(19) United States
(12) Patent Application Publication
(10) Pub. No.: US 2011/0002680 A1
(43) Pub. Date: Jan. 6, 2011

(54) METHOD AND APPARATUS FOR FOCUSING AN IMAGE OF AN IMAGING DEVICE

(75) Inventors: Rajesh Narasimha, Dallas, TX (US); Peter Labaziewicz, Allen, TX (US); Youngjun F. Yoo, Plano, TX (US); Namjin Kim, Dallas, TX (US); Bruce E. Flinchbaugh, Dallas, TX (US); Hamid R. Sheikh, Allen, TX (US); Mark N. Gamadia, Richardson, TX (US)

Correspondence Address: TEXAS INSTRUMENTS INCORPORATED, P O BOX 655474, M/S 3999, DALLAS, TX, 75265, US

(73) Assignee: Texas Instruments Incorporated, Dallas, TX (US)

(21) Appl. No.: 12/496,782

(22) Filed: Jul. 2, 2009

(51) Int. Cl. G03B 3/00

(52) U.S. Cl. 396/124; 396/89

(57) ABSTRACT

A method and apparatus for focusing an image in an image-capturing device utilizing at least one face in the image. The method includes detecting at least one face in the image, determining the size of the detected at least one face, determining the distance of the at least one face from the image-capturing device, wherein the determination utilizes the size of the detected at least one face, and focusing an image according to the determined distance of the detected at least one face.

### BACKGROUND OF THE INVENTION

1. Field of the Invention

Embodiments of the present invention generally relate to a method and apparatus for focusing an image of an imaging device utilizing at least one face in the image.

2. Background of the Invention

Automatic focus or autofocus is an important component of imaging devices, such as, a digital camera, camcorders and the like. The purpose of the autofocus is to move the lens to the correct position such that the subject of a photograph is focused. Human faces are often the subject of photographs and face detection components are becoming more common. A typical autofocus determines the subject of the photograph based on finding the best focused object while the lens is moved, but an autofocus system paired with face detection can assume that the subject is the detected face. Autofocus systems with face detection can improve the accuracy of focus with greater knowledge of the subject of the photograph.

The autofocus introduces a delay between the time the image is intended to be taken, i.e. time of actually pressing the exposure button, and the time the image is actually taken after the automatic focus. The amount of time it takes for the autofocus to achieve focus lock is an important metric. Many times, the image actually intended to be captured is not the image actually captured.

Therefore, there is a need for an improved method and apparatus for focusing an image while minimizing the resulting time delay.

### SUMMARY OF THE INVENTION

Embodiments of the present invention relate to a method and apparatus for focusing an image in an image-capturing device utilizing at least one face in the image. The method includes detecting at least one face in the image, determining the size of the detected at least one face, determining the distance of the at least one face from the image-capturing device, wherein the determination utilizes the size of the detected at least one face, and focusing an image according to the determined distance of the detected at least one face.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments. In this application, a computer readable medium is any medium accessible by a computer for saving, writing, archiving, executing and/or accessing data.

FIG. 1 is an embodiment of an apparatus for focusing an image;

FIG. 2 is an embodiment of a system for focusing an image;

FIG. 3 is a flow diagram depicting an embodiment of a method for focusing an image;

FIG. 4 is an embodiment of description of a range estimation;

FIG. 5 is an embodiment of a camera equipped with face detection algorithm;

FIG. 6 is an embodiment depicting a high-level overview of single-shot passive autofocus; and

FIG. 7 is an embodiment depicting utilizing the facial focus method on an image with multiple faces.

### DETAILED DESCRIPTION

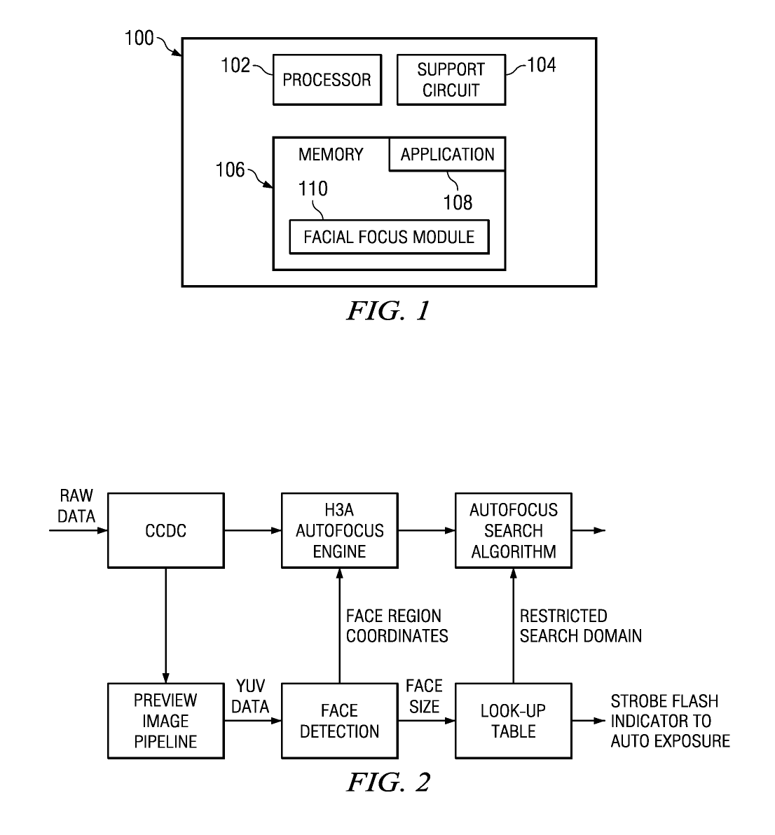

FIG. 1 is an embodiment of an apparatus 100 for focusing an image. The apparatus 100 includes a processor 102, support circuitry 104, and memory 106.

The processor 102 may comprise one or more conventionally available microprocessors. The microprocessor may be an application specific integrated circuit (ASIC). The support circuits 104 are well known circuits used to promote functionality of the processor 102. Such circuits include, but are not limited to, a cache, power supplies, clock circuits, input/output (I/O) circuits and the like. The memory 106 may comprise random access memory, read only memory, removable disk memory, flash memory, and various combinations of these types of memory. The memory 106 is sometimes referred to main memory and may, in part, be used as cache memory or buffer memory. The memory 106 may store an operating system (OS), database software, statistical data and various forms of application software, such as, applications 108 and facial focus module 110.

The applications 108 are any applications that are stored or utilized by the apparatus 100. The facial focus module 110 is utilized to detect a face in an image and utilizing the face area, estimate the distance and size of the face, to automatically obtain an optimal focused image. For example, the facial focus module 110 may be utilized to detect a face, the size of the face, the distance of the face from the camera and then focusing the image accordingly. The facial focus module 110 is better described below.

The facial focus module 110 detects faces in an image in order for the autofocus to reduce the amount of time to achieve focus lock. The facial focus module 110 is also utilized to determine the distance of the subject in the image. The determined distance is necessary for determining the automatic functioning of the strobe flash. The strobe flash is set to ON position when the subject distance is greater than a pre-determined threshold value. This helps in better images in low light conditions. The facial focus module utilizes the face size information to speed up the autofocus (AF) convergence time and as an indicator for the use of strobe flash.

FIG. 2 is an embodiment of a system for focusing an image. As shown in FIG. 2, the image sensor provides Bayer pattern raw data to a CCD controller (CCDC) on the processor. The CCDC outputs the image data to a preview image pipeline and hardware, such as, 3A (AE/AWB/AF) (H3A) engine. The preview image pipeline transforms the Bayer pattern raw data into YUV raw data, which is then subsequently, processed using a face detection algorithm to determine the coordinates of the face region. This face region is converted into physical distance using a look-up-table and then used to fire the strobe flash.

The H3A's autofocus engine is used to analyze the sharpness information in the face detected focus region in real-time, the result of which is then stored to a buffer in the memory. The search algorithm is executed using the sharpness information from the filled autofocus buffer. Feedback is sent to the focus lens for focus motor movement and also to the display for highlighting the focus region used to determine the in-focus position. The auto-focus algorithm may be a software task running on the processor and is executed, for example, by half-pressing shutter button.

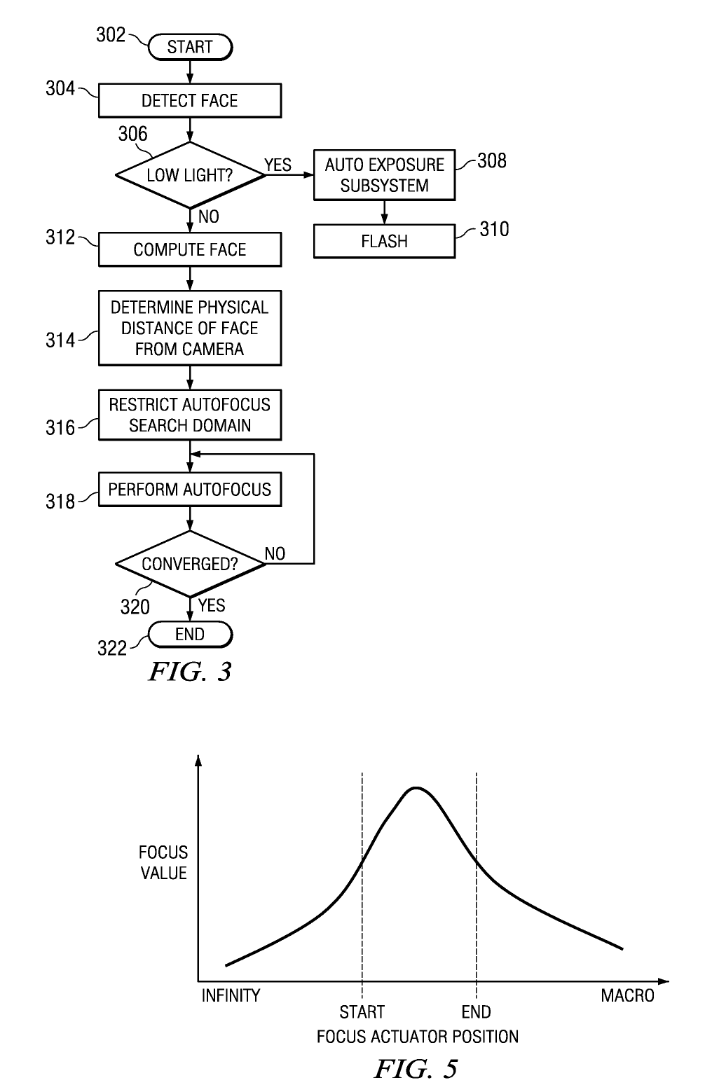

FIG. 3 is a flow diagram depicting an embodiment of a method 300 for focusing an image. The method 300 starts at step 302 and proceeds to step 304. At step 304, the method 300 detects a face. At step 306, the method 300 determines if the image is in low light. If the image is in low light, the method 300 utilizes auto exposure subsystem in step 308 and proceeds to step 310. At step 310, flash is triggered and the method proceeds to step 312. If the light conditions are not low, the method proceeds from step 306 to step 312. At step 312, the method 300 computes the face size. At step 314, the method 300 determines the physical distance of the face from the camera, i.e. through a look-up table that relates a face size to physical distance. At step 316, the physical distance is then used to restrict its search domain and to indicate the use/need of a flash, i.e., a strobe flash, for near object distance image capture. At step 318, autofocus is performed. At step 320, if the image is converged, the method 300 proceeds to step 318; otherwise, the method 300 proceeds to step 322. The method ends at 314.

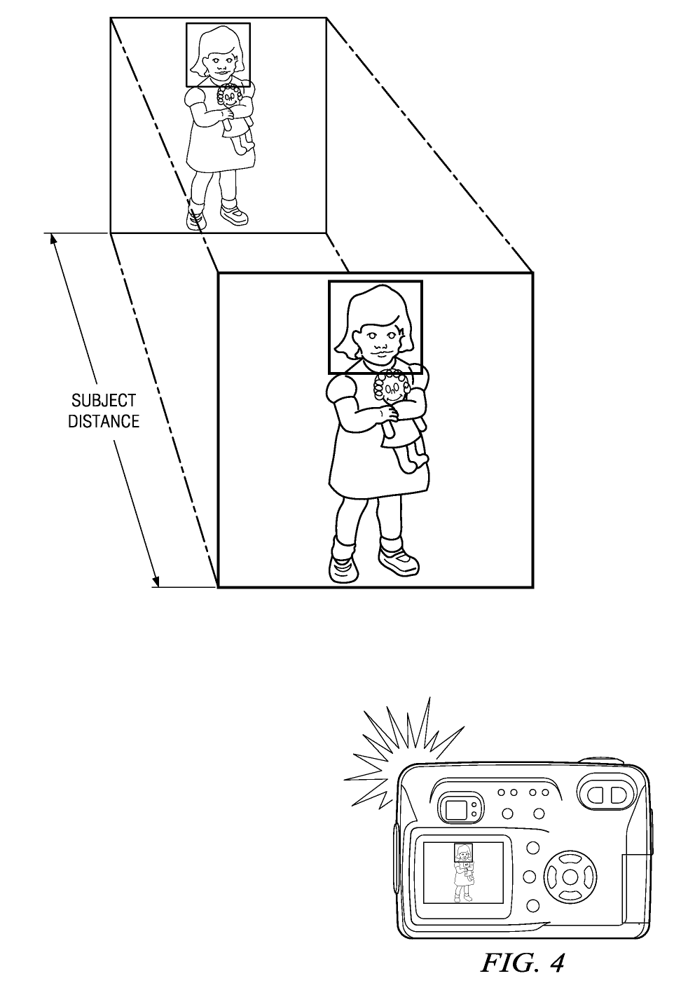

FIG. 4 is an embodiment of description of a range estimation. FIG. 4 illustrates the relationship between a face size and the physical distance. Based on the LUT that maps distance from the camera to the size of human faces, the distance between the camera and the face can be estimated. The estimate can serve as the starting point for the autofocus, thus, shortening the amount of time it takes to lock focus on the subject.

Utilizing the facial focus, the autofocus rapidly refines the search around the estimated location to find the best focus position. In another embodiment, the facial focus may also be used to provide more reliable estimates, such as, measuring distances between various features of the detected face (distance between eyes). Using the face size as an indication of object distance, the autofocus search domain can be restricted to search a limited number of positions around the estimated distance denoted by start and end shown in FIG. 5 and, thus, reduce autofocus convergence time considerably.

Autofocus is an important feature in image capture devices such as digital still cameras or camera phones. The purpose of autofocus is to rapidly bring an object of interest into focus by adjusting the focus motor position when the shutter button is half-pressed. In order to develop a complete autofocus solution, appropriate choices need to be made regarding focus region, sharpness function and search algorithm.

The most popular approach to the autofocus feature is based on the widely adopted passive approach, which uses image analysis to extract a measure of sharpness from focus regions within an image. The in-focus position is found by locating the maximum of a sharpness function computed from the captured image at different lens positions. This allows the autofocus to be implemented as a feedback control loop in software.

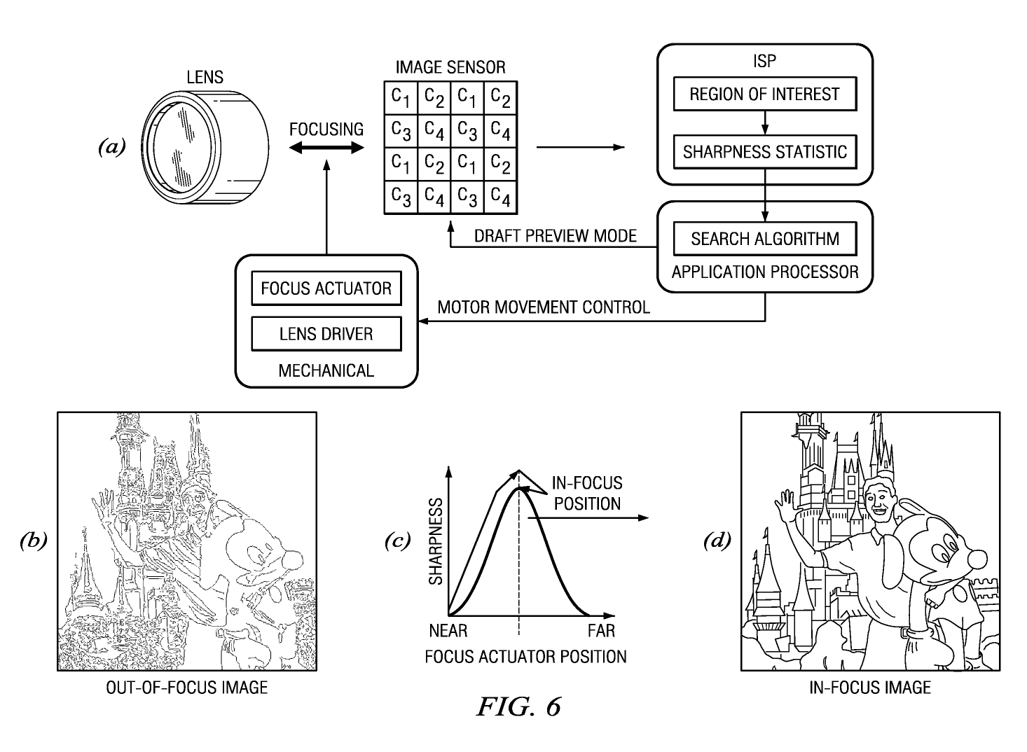

A high-level overview of a generic autofocus system is shown in FIG. 6. In one embodiment the focus of the image, as described in FIG. 2 is performed utilizing the generic autofocus system of FIG. 6. The autofocus system FIG. 6 includes: (a) feedback control loop, (b) out-of-focus scene before autofocus, (c) sharpness function and search algorithm movement, and (d) in-focus image captured with in-focus position determined by autofocus. As illustrated in this FIG. 6, the input to the autofocus is the Bayer pattern, live draft preview image. This image is then processed to extract some sharpness information from a pre-specified sub-set of the image known as the focus region. In this invention, the focus region would be set to that of the detected face region. Finally, the extracted sharpness information is then passed to a search algorithm, which decides the amount of the focus motor movement for the next iteration. The search continues until the peak location (in-focus position) is passed by a few steps, at which point, the focus actuator is moved back to the found in-focus position.

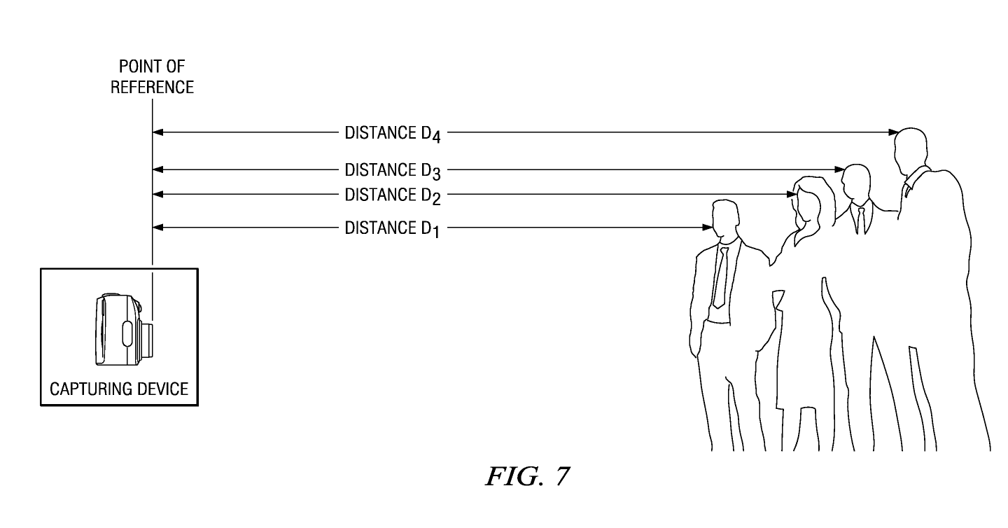

FIG. 7 is an embodiment depicting utilizing the facial focus on an image with multiple faces. In FIG. 7, the image-capturing device 702 includes a facial focus module 110 (FIG. 1). In this embodiment, the facial focus module 110 detects three (3) faces, face 704, 706 and 708. The four (4) faces 704, 706 and 708 may be in similar distance or of the same distance, i.e. D₁, D₂ D₃ and D₄. If the facial focus module 110 determines that the faces are of the same distance from the image-capturing device, such a distance is utilized to determine the appropriate focus. If the faces 704, 706 and 708 are of different distances, the facial focus module 110 may average the determined distance, determine the best total focus utilizing the various distances, or allow the user to choose the face to be whose distance is to be utilized for focusing. The user may be able to view the focus utilizing the various distances to assist in the decision.

Since human faces have similar sizes, the face size in the image can be a reliable reference for estimating subject distance. Thus utilizing the face detection, size and distance, a smaller time delay is experienced for auto-focusing of an image system. Such a solution may utilize a look-up table approach that maps the subject distance to the face size and, hence, is computationally inexpensive.

While the foregoing is directed to embodiments of the present invention, other and further embodiments of the invention may be devised without departing from the basic scope thereof, and the scope thereof is determined by the claims that follow.

1. A method for focusing an image in an image-capturing device utilizing at least one face in the image, the method comprising:
detecting at least one object in the image;
determining the size of the detected at least one object;
automatically determining which object to utilize for auto focus by determining the distance of the object from the image-capturing device and by utilizing face detection; and
focusing an image according to the determined distance of the detected at least one object.

2. The method of claim 1, wherein the step of determining the distance comprises at least one of:
utilizing reference data relating face size to distance of a face from the image-capturing device;
utilizing the average of multiple distances of multiple faces to determine the distance utilized for focusing the image;
utilizing one the distances of multiple faces in the image, wherein the utilized distance provides the best focus; or
requesting a user to select the face whose distance is utilized for focusing the image.

3. The method of claim 2, wherein the user utilizes at least one of a menu, a touch screen, a presetting or a voice command to select the face whose distance is utilized for focusing the image.

4. The method of claim 1, wherein the method of focusing an image utilizing at least one face in the image is executed during autofocus.

5. The method of claim 1, wherein the method of focusing an image utilizing at least one face in the image can be bypassed or executed by turning on or off an option in the image-capturing device.

6. The method of claim 1, wherein the method allows a user to set preferences utilized when the method is executed.

7. An apparatus for focusing an image in an image-capturing device utilizing at least one face in the image, the method comprising:
means for detecting at least one face in the image;
means for determining the size of the detected at least one face;
means for automatically determining which object to utilize for auto focus by determining the distance of the object from the image-capturing device and by utilizing face detection; and
means for focusing an image according to the determined distance of the detected at least one face.

8. The apparatus of claim 7, wherein the means for determining the distance comprises at least one of:
means for utilizing reference data relating face size to distance of a face from the image-capturing device;
means for utilizing the average of multiple distances of multiple faces to determine the distance utilized for focusing the image;
means for utilizing one the distances of multiple faces in the image, wherein the utilized distance provides the best focus; or
means for requesting a user to select the face whose distance is utilized for focusing the image.

9. The apparatus of claim 8, wherein the user utilizes at least one of a menu, a touch screen, a presetting, a voice command or gesture to select the face whose distance is utilized for focusing the image.

10. The apparatus of claim 7, wherein the apparatus for focusing an image utilizing at least one face in the image is utilized by autofocus of the image-capturing device.

11. The apparatus of claim 7, wherein the apparatus for focusing an image utilizing at least one face in the image can be bypassed or executed by turning on or off an option in the image-capturing device.

12. The apparatus of claim 7, wherein the apparatus allows a user to set preferences utilized when the focus utilizing the face is utilized.

13. A computer readable medium comprising software that, when executed by a processor, causes the processor to perform a method for focusing an image in an image-capturing device utilizing at least one face in the image, the method comprising:
detecting at least one face in the image;
determining the size of the detected at least one face;
automatically determining which object to utilize for auto focus by determining the distance of the object from the image-capturing device and by utilizing face detection; and
focusing an image according to the determined distance of the detected at least one face.

14. The computer readable medium of claim 13, wherein the step of determining the distance comprises at least one of:
utilizing reference data relating face size to distance of a face from the image-capturing device;
utilizing the average of multiple distances of multiple faces to determine the distance utilized for focusing the image;
utilizing one the distances of multiple faces in the image, wherein the utilized distance provides the best focus; or
requesting a user to select the face whose distance is utilized for focusing the image.

15. The computer readable medium of claim 14, wherein the user utilizes at least one of a menu, a touch screen, a presetting or a voice command to select the face whose distance is utilized for focusing the image.

16. The computer readable medium of claim 13, wherein the method of focusing an image utilizing at least one face in the image is executed during autofocus.

17. The computer readable medium of claim 13, wherein the method of focusing an image utilizing at least one face in the image can be bypassed or executed by turning on or off an option in the image-capturing device.

18. The computer readable medium of claim 13, wherein the method allows a user to set preferences utilized when the method is executed.
